(19) United States
(12) Patent Application Publication
(10) Pub. No.: US 2024/0326566 A1
(43) Pub. Date: Oct. 3, 2024

(54) SUNROOF APPARATUS

(71) Applicant: AISIN CORPORATION, Kariya (JP)

(72) Inventors: Atsushi TAKEMOTO, Kariya-shi (JP); Hiroki SHINKAWA, Kariya-shi (JP); Tomonori SHIMIZU, Kariya-shi (JP); Hidekazu YAMADA, Kariya-shi (JP)

(73) Assignee: AISIN CORPORATION, Kariya (JP)

(21) Appl. No.: 18/617,025

(22) Filed: Mar. 26, 2024

(30) Foreign Application Priority Data
Mar. 31, 2023 (JP) 2023-056980

(51) Int. Cl. B60J 7/043; B60J 3/00; B60J 3/04

(52) U.S. Cl. CPC B60J 7/0435; B60J 3/007; B60J 3/04

(57) ABSTRACT

A sunroof apparatus includes a movable panel and a fixed panel, and is equipped on a vehicle. The sunroof device includes a movable-side dimming film provided on the movable panel, a fixed-side dimming film provided on the fixed panel, a movable-side dimming film drive device that drives the movable-side dimming film, a fixed-side dimming film drive device that drives the fixed-side dimming film, a movable-side sensor attached to the movable panel to acquire a transmittance of the movable panel, a fixed-side sensor attached to the fixed panel to acquire a transmittance of the fixed panel, and a control device that controls at least one of the movable-side dimming film drive device and the fixed-side dimming film drive device so that the transmittance of at least one of the movable panel and the fixed panel is changed, based on a detection value of at least one of the movable-side sensor and the fixed-side sensor.

### CROSS REFERENCE TO RELATED APPLICATIONS

This application is based on and claims priority under 35 U.S.C. § 119 to Japanese Patent Application 2023-056980, filed on Mar. 31, 2023, the entire content of which is incorporated herein by reference.

### TECHNICAL FIELD

The present disclosure relates to a sunroof apparatus that includes a movable panel and a fixed panel and is equipped on a vehicle.

### BACKGROUND DISCUSSION

In the related art, laminated glass for vehicles in which an optical sensor is incorporated is known (for example, refer to JP 2018-537377A (Reference 1)). This laminated glass includes an outer glass and an inner glass bonded to each other via a thermoplastic film. In addition, a printed circuit substrate including a plurality of photodiodes (SMD components) is disposed between the outer glass and the inner glass, and the printed circuit substrate functions as the optical sensor that detects the amount of ambient light. Furthermore, a functional element such as a liquid crystal dimming film is disposed in a predetermined area of the laminated glass, and the functional element is electrically switched or controlled depending on the amount of ambient light detected by at least one photodiode. As a result, the transmission characteristics in a predetermined area of the laminated glass can be electrically switched or controlled.

However, in JP 2018-537377A (Reference 1), no consideration is given to applying the laminated glass to a sunroof apparatus including a movable panel and a fixed panel. Furthermore, by simply monitoring the amount of ambient light, there is a possibility that the transmission characteristics of the sunroof apparatus cannot be appropriately controlled in response to changes in ambient brightness while the vehicle is running.

A need thus exists for a sunroof apparatus which is not susceptible to the drawback mentioned above.

### SUMMARY

According to an aspect of this disclosure, a sunroof apparatus of the present disclosure includes a movable panel and a fixed panel, and is equipped on a vehicle, the device including a movable-side dimming film provided on the movable panel, a fixed-side dimming film provided on the fixed panel, a movable-side dimming film drive device that drives the movable-side dimming film, a fixed-side dimming film drive device that drives the fixed-side dimming film, a movable-side sensor attached to the movable panel to acquire a transmittance of the movable panel, a fixed-side sensor attached to the fixed panel to acquire a transmittance of the fixed panel, and a control device that controls at least one of the movable-side dimming film drive device and the fixed-side dimming film drive device so that the transmittance of at least one of the movable panel and the fixed panel is changed, based on a detection value of at least one of the movable-side sensor and the fixed-side sensor.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration diagram illustrating a sunroof apparatus of the present disclosure;

FIG. 2 is a cross-sectional view schematically illustrating a movable panel and a fixed panel of the sunroof apparatus of the present disclosure;

FIG. 3 is a cross-sectional view schematically illustrating the movable panel and the fixed panel of the sunroof apparatus of the present disclosure;

FIG. 4 is a control block diagram of the sunroof apparatus of the present disclosure;

FIG. 5 is a chart illustrating a target voltage setting map used in the sunroof apparatus of the present disclosure;

FIG. 6 is a flowchart illustrating a target voltage setting routine executed in the sunroof apparatus of the present disclosure; and

FIG. 7 is a flowchart illustrating a target voltage setting routine executed in the sunroof apparatus of the present disclosure.

### DETAILED DESCRIPTION

Next, embodiments disclosed here will be described with reference to the drawings.

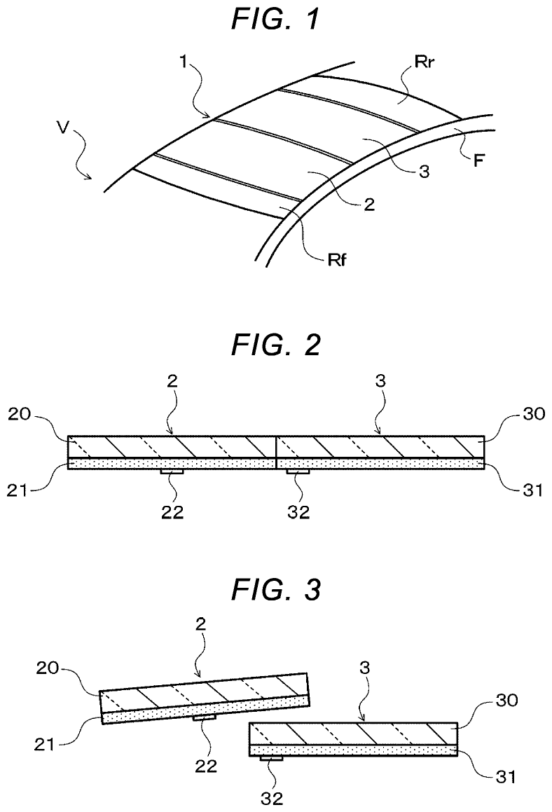

FIG. 1 is a schematic configuration diagram illustrating a sunroof apparatus 1 of the present disclosure. The sunroof apparatus 1 includes a movable panel 2 and a fixed panel 3 that cover an opening portion formed between a front roof panel Rf and a rear roof panel Rr, each of which is fixed to a vehicle body F of a vehicle V. As illustrated in FIG. 2, the movable panel 2 includes a panel body 20 made of a material with high light transmittance, such as glass or resin, and a movable-side dimming film 21 laminated (fixed) on the inner surface of the panel body 20. In addition, as illustrated in FIG. 2, the fixed panel 3 includes a panel body 30 made of a material with high light transmittance, such as glass or resin, and a fixed-side dimming film 31 laminated (fixed) on the inner surface of the panel body 30. However, the movable-side dimming film 21 and the fixed-side dimming film 31 may be laminated between two transparent panels forming the movable panel 2 or the fixed panel 3.

The movable-side dimming film 21 and the fixed-side dimming film 31 include two transparent base materials, two electrode layers laminated on each of the corresponding base materials, and a dimming film laminated between the two electrode layers. The two base materials are, for example, polyethylene terephthalate (PET) films (sheets). The two electrode layers are made of, for example, diamond-like carbon (DLC) or indium tin oxide (ITO), and are laminated on the inner surface of the corresponding base material by, for example, vapor deposition. For example, the dimming film is a polymer dispersed liquid crystal that is cloudy (opaque) when no voltage is applied to the two electrode layers, and becomes approximately transparent when a voltage is applied to the two electrode layers. Therefore, by adjusting the voltage applied to the movable-side dimming film 21, the transmittance of the movable panel 2 can be changed, and by adjusting the voltage applied to the fixed-side dimming film 31, the transmittance of the fixed panel 3 can be changed. In the present embodiment, the movable-side dimming film 21 and the fixed-side dimming film 31 have the same specifications. However, the specifications of the movable-side dimming film 21 and the fixed-side dimming film 31 may be different from each other.

The movable panel 2 is slidably supported in the front-rear direction of the vehicle V by a pair of left and right guide rails (not illustrated) fixed to the vehicle body F so as to be located behind the front roof panel Rf, and can be opened and closed in the front-rear direction. The fixed panel 3 is fixed to the vehicle body F so as to cover the opening portion between the completely closed movable panel 2 and the rear roof panel Rr. In the present embodiment, when the movable panel 2 is opened, as illustrated in FIG. 3, the movable panel 2 is tilted up by a tilt mechanism (not illustrated) and slides to overlap the fixed panel 3 at the rear. In addition, when the movable panel 2 is completely closed, the front roof panel Rf, the movable panel 2, the fixed panel 3, and the rear roof panel Rr are approximately flush with each other. An openable/closable shade (light shielding member) (not illustrated) may be provided below the movable panel 2 and the fixed panel 3.

In addition, a movable-side sensor 22 is attached to the inner surface (vehicle-interior-side surface) of the movable panel 2, that is, the movable-side dimming film 21, in order to detect the transmittance of the movable panel 2. In the present embodiment, the movable-side sensor 22 is attached to one side portion of the inner surface of the movable-side dimming film 21 so as to be located near the center of the vehicle V in the front-rear direction. Furthermore, a fixed-side sensor 32 is attached to the inner surface (vehicle-interior-side surface) of the fixed panel 3, that is, the fixed-side dimming film 31, in order to detect the transmittance of the fixed panel 3. In the present embodiment, the fixed-side sensor 32 is attached to one side portion of the inner surface of the fixed-side dimming film 31 so as to be located near the front end of the vehicle V in the front-rear direction. In the present embodiment, the movable-side sensor 22 and the fixed-side sensor 32 are photodiodes that output a voltage depending on the intensity of input light (received light), that is, the transmittance of the movable panel 2 or the fixed panel 3. In addition, as illustrated in FIG. 3, when the movable panel 2 at least partially overlaps the fixed panel 3, the fixed-side sensor 32 receives the light passed through both the movable panel 2 and the fixed panel 3.

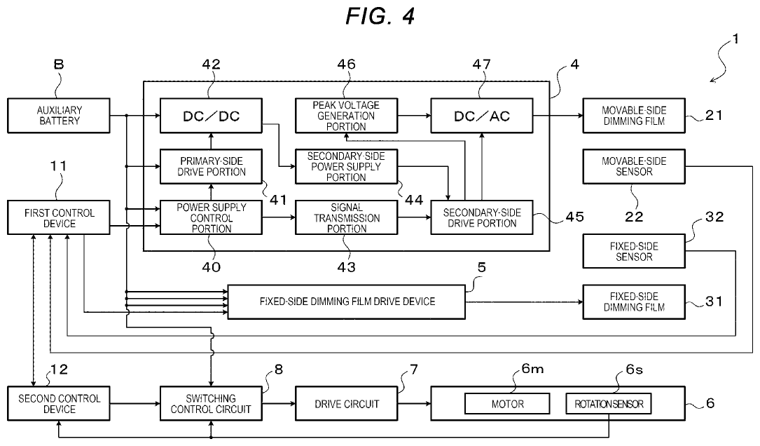

Furthermore, as illustrated in FIG. 4, the sunroof apparatus 1 includes a movable-side dimming film drive device 4, a fixed-side dimming film drive device 5, an actuator 6, a drive circuit 7, a switching control circuit 8, a first control device 11, and a second control device 12. The movable-side dimming film drive device 4 drives the movable-side dimming film 21 of the movable panel 2, and the fixed-side dimming film drive device 5 drives the fixed-side dimming film 31 of the fixed panel 3. The actuator 6 slides the movable panel 2 in the front-rear direction of the vehicle V. The drive circuit 7 is controlled by the switching control circuit 8 and supplies power to the actuator 6 to drive the actuator 6. The first control device 11 controls the movable-side dimming film drive device 4 and the fixed-side dimming film drive device 5, and the second control device 12 controls the actuator 6. The first and second control devices 11 and 12 mutually exchange information necessary for control.

As illustrated in FIG. 4, the movable-side dimming film drive device 4 includes a power supply control portion 40, a primary-side drive portion 41, a DC/DC converter 42, a signal transmission portion 43, a secondary-side power supply portion 44, a secondary-side drive portion 45, a peak voltage generation portion 46, and a DC/AC inverter 47 as functional blocks.

The power supply control portion 40 controls the voltage applied to the movable-side dimming film 21 and the timing of the voltage supply based on a target value transmitted from the first control device 11. When receiving the target value from the first control device 11, the power supply control portion 40 transmits a control signal to the primary-side drive portion 41 and the signal transmission portion 43. The primary-side drive portion 41 is activated by a control signal from the power supply control portion 40, steps down the voltage (DC voltage, for example, approximately 12V) supplied from an auxiliary battery B of the vehicle V to a predetermined voltage (for example, approximately 5V), and controls the DC/DC converter 42 using the stepped down voltage.

The DC/DC converter 42 includes a plurality of switching elements and the like that are controlled to open and close by the primary-side drive portion 41, and is a step-up converter that steps up the voltage supplied from the auxiliary battery B of the vehicle V to a voltage suitable for driving the movable-side dimming film 21 (for example, approximately 120V) to output the voltage. The voltage (DC voltage) output from the DC/DC converter 42 is supplied to the secondary-side power supply portion 44 and the peak voltage generation portion 46. The signal transmission portion 43 is, for example, a photocoupler, and transmits the control signal from the power supply control portion 40 to the secondary-side drive portion 45 in an insulated state. The secondary-side power supply portion 44 is, for example, a regulator, and steps down the DC voltage (for example, approximately 120V) supplied from the DC/DC converter 42 to a voltage (for example, 12V) suitable for driving the secondary-side drive portion 45 and supplies the voltage to the secondary-side drive portion 45.

The secondary-side drive portion 45 is activated by a control signal from the power supply control portion 40 transmitted via the signal transmission portion 43, and controls the peak voltage generation portion 46 and the DC/AC inverter 47 based on the control signal using the voltage from the secondary-side drive portion 45. The peak voltage generation portion 46 includes a plurality of switching elements and the like that are controlled to open and close by the secondary-side drive portion 45. The peak voltage generation portion 46 generates either a peak voltage or a base voltage lower than the peak voltage based on the DC voltage supplied from the DC/DC converter 42 in response to a command from the secondary-side drive portion 45 and supplies the generated voltage to the DC/AC inverter 47. The DC/AC inverter 47 converts the peak voltage or base voltage supplied from the peak voltage generation portion 46 into a rectangular waveform AC voltage and applies the AC voltage to the movable-side dimming film drive device 4.

The fixed-side dimming film drive device 5 has a common configuration with the movable-side dimming film drive device 4. That is, the fixed-side dimming film drive device 5 also includes a power supply control portion, a primary-side drive portion, a DC/DC converter (step-up converter), a signal transmission portion, a secondary-side power supply portion, a secondary-side drive portion, a peak voltage generation portion, and a DC/AC inverter as functional blocks.

The actuator 6 includes a pair of drive cables (not illustrated), a drive gear (not illustrated), a motor 6m, and a rotation sensor 6s, and is disposed, for example, on the rear side of the front roof panel Rf. The pair of drive cables are routed along the left and right guide rails. The drive gear meshes with each drive cable at two positions symmetrical with respect to the axis. The motor 6m is a brushed DC motor in the present embodiment, and rotationally drives the drive gear. The rotation sensor 6s is a pulse sensor that outputs a pulse signal synchronized with the rotation of the motor 6m, and detects the rotational position of the motor 6m. In addition, the drive circuit 7 is a PWM inverter including a plurality of switching elements (FETs) connected in a bridge shape. Furthermore, the switching control circuit 8 controls the opening and closing of the plurality of switching elements of the drive circuit 7 based on the command signal from the second control device 12 and the pulse signal from the rotation sensor 6s.

The first control device 11 is a microcomputer having a CPU, ROM, RAM, input/output interface, and the like. The first control device 11 acquires signals from a movable-side dimmer switch (not illustrated) for adjusting the transmittance of the movable panel 2 and a fixed-side dimmer switch (not illustrated) for adjusting the transmittance of the fixed panel 3. Furthermore, the first control device 11 acquires the detection value of the movable-side sensor 22 of the movable panel 2 and the detection value of the fixed-side sensor 32 of the fixed panel 3. The movable-side dimmer switch and the fixed-side dimmer switch may be operable by voice.

In addition, the first control device 11 sets a target voltage Vm*, which is a target value of the voltage (AC voltage) applied to the movable-side dimming film 21, and transmits the set target voltage Vm* to the power supply control portion 40 of the movable-side dimming film drive device 4, so that the transmittance of the movable panel 2 corresponding to the output voltage (detection value) Vsm of the movable-side sensor 22 becomes the target transmittance (required value) set by an occupant of the vehicle V via the movable-side dimmer switch. As a result, a voltage corresponding to the target voltage Vm* is applied from the movable-side dimming film drive device 4 to the movable-side dimming film 21 of the movable panel 2. Furthermore, the first control device 11 sets a target voltage Vf* of the voltage applied to the fixed-side dimming film 31, and transmits the set target voltage Vf* to the power supply control portion of the fixed-side dimming film drive device 5, so that the transmittance of the fixed panel 3 corresponding to the output voltage (detection value) Vsf of the fixed-side sensor 32 becomes the target transmittance (required value) set by the occupant via the fixed-side dimmer switch. As a result, the voltage corresponding to the target voltage Vf* is applied from the fixed-side dimming film drive device 5 to the fixed-side dimming film 31 of the fixed panel 3.

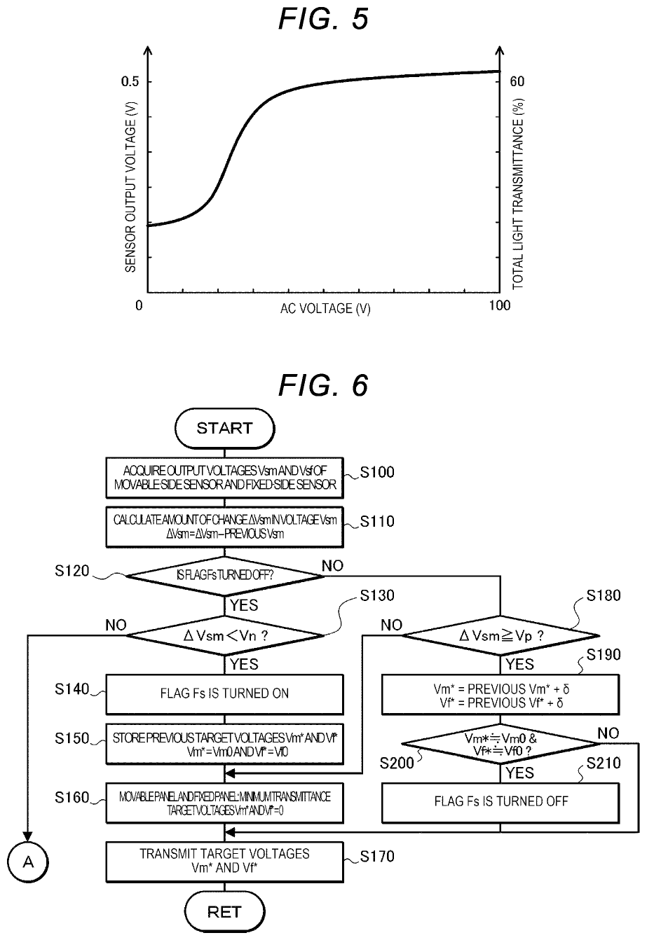

In the present embodiment, the first control device 11 sets target voltages Vm* and Vf* by PID control using the target voltage setting map illustrated in FIG. 5 so that the transmittance of the movable panel 2 and the fixed panel becomes the target transmittance set by the occupant. The target voltage setting map is predetermined through experiments and analysis so as to define the relationship between the voltage (AC voltage) applied to the movable-side dimming film 21 or the fixed-side dimming film 31 by the movable-side dimming film drive device 4 or the fixed-side dimming film drive device 5, the output voltages Vsm and Vsf of the movable-side sensor 22 and the fixed-side sensor 32, and the total light transmittance of the movable panel 2 and the fixed panel 3. As illustrated in the drawing, the total light transmittance of the movable panel 2 and the fixed panel 3 increases as the voltage (AC voltage) applied to the movable-side dimming film 21 or the fixed-side dimming film 31 increases, and the output voltages Vsm and Vsf of the movable-side sensor 22 and the fixed-side sensor 32 also increase as the total light transmittance of the movable panel 2 or the fixed panel 3 increases. When the voltage applied to the movable-side dimming film 21 or the fixed-side dimming film 31 is equal to or greater than a predetermined value, the total light transmittance of the movable panel 2 and the fixed panel 3, and each of the output voltages Vsm and Vsf of the movable-side sensor 22 and the fixed-side sensor 32 converges to approximately constant values.

The second control device 12 is a microcomputer having a CPU, ROM, RAM, input/output interface, and the like. The second control device 12 acquires signals from a roof opening/closing switch of the movable panel 2 and a tilt switch of the movable panel 2, both of which are not illustrated, and a pulse signal from the rotation sensor 6s of the actuator 6. When the roof opening/closing switch or the tilt switch is operated by the occupant of the vehicle V, the second control device 12 generates a command signal in response to a request of the occupant (fully opening, partially opening, fully closing, and tilting up of the movable panel 2) and transmits the command signal to the switching control circuit 8. The switching control circuit 8 performs switching control on the drive circuit 7 in response to a command signal from the second control device 12 so that the movable panel 2 is in a state in response to the request of the occupant. As a result, the movable panel 2 is moved by the actuator 6 to a position in response to the request of the occupant. The roof opening/closing switch and the tilt switch may be operable by voice.

As described above, in the sunroof apparatus 1, the movable panel 2 is provided with the movable-side dimming film 21, and the fixed panel 3 is provided with the fixed-side dimming film 31. Furthermore, the movable-side sensor 22 is attached to the movable panel 2 in order to acquire the transmittance of the movable panel 2, and the fixed-side sensor 32 is attached to the fixed panel 3 in order to acquire the transmittance of the fixed panel 3. As a result, at least one of the movable-side dimming film drive device 4 and the fixed-side dimming film drive device 5 is controlled so that the transmittance of at least one of the movable panel 2 and the fixed panel 3 is changed based on at least one of the output voltages Vsm and Vsf of the movable-side sensor 22 and the fixed-side sensor 32, and the transmittance of the movable panel 2 and the fixed panel 3 can be individually adjusted with high precision. As a result, it is possible to further improve the light transmission characteristics of the sunroof apparatus 1 including the movable panel 2 and the fixed panel 3.

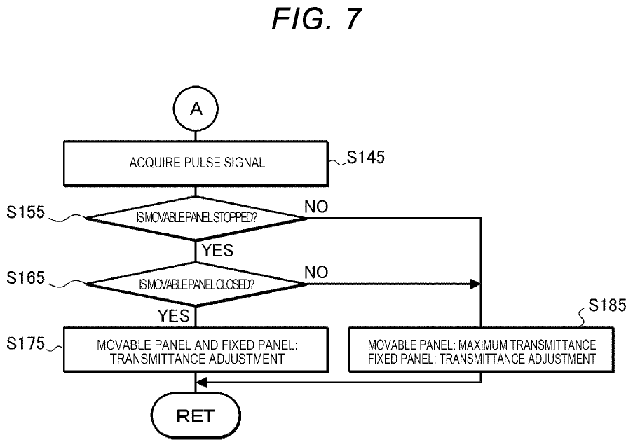

Next, a procedure for setting target voltages Vm* and Vf* by the first control device 11 of the sunroof apparatus 1 will be described with reference to FIGS. 6 and 7.

FIG. 6 is a flowchart illustrating an example of a target voltage setting routine repeatedly executed by the first control device 11 at predetermined time (minute time, for example, 10 msec to several tens of msec) intervals, while the system of the vehicle V is activated and dimming of the movable panel 2 and the fixed panel 3 is requested by the occupant of the vehicle V via the movable-side dimmer switch and the fixed-side dimmer switch. When the execution timing of the target voltage setting routine arrives, the first control device 11 acquires the output voltages Vsm and Vsf of the movable-side sensor 22 and the fixed-side sensor 32 (step S100). Next, the first control device 11 calculates the amount of change ΔVsm (amount of change per execution cycle of target voltage setting routine) in the output voltage Vsm by subtracting the output voltage Vsm (previous value) of the movable-side sensor 22 acquired in step S100 during the previous execution of the target voltage setting routine from the output voltage Vsm of the movable-side sensor 22 acquired in step S100 (step S110).

Furthermore, the first control device 11 determines whether or not a predetermined flag Fs is turned off (step S120), and when the flag Fs is turned off (step S120: YES), determines whether or not the amount of change ΔVsm in the output voltage Vsm of the movable-side sensor 22 calculated in step S110 is less than a predetermined sharp decrease determination threshold Vn (step S130). The sharp decrease determination threshold Vn is a negative value determined in advance through experiments and analysis so that it can be determined that the amount of light incident on the vehicle interior has sharply decreased in a short time. When where the amount of change ΔVsm is equal to or greater than the sharp decrease determination threshold Vn and the output voltage Vsm of the movable-side sensor 22, that is, the transmittance of the movable panel 2 is not sharply decreased (step S130: NO), as illustrated in FIG. 7, the first control device 11 acquires a pulse signal from the rotation sensor 6s of the actuator 6 from the second control device 12 (step S145), and determines whether or not the movable panel 2 is stopped (step S155).

When the movable panel 2 is stopped (step S155: YES), the first control device 11 determines whether or not the movable panel 2 is closed (step S165). When the movable panel 2 is closed (step S165: YES), the first control device 11 uses the target voltage setting map illustrated in FIG. 5 to set the target voltage Vm* of the voltage applied to the movable-side dimming film 21 so that the transmittance of the movable panel 2 corresponding to the output voltage (detection value) Vsm of the movable-side sensor 22 acquired in step S100 becomes the target transmittance set by the occupant of vehicle V via the movable-side dimmer switch (step S175). In addition, in step S175, the first control device 11 uses the target voltage setting map illustrated in FIG. 5 to set the target voltage Vf* of the voltage applied to the fixed-side dimming film 31 so that the transmittance of the fixed panel 3 corresponding to the output voltage (detection value) Vsf of the fixed-side sensor 32 acquired in step S100 becomes the target transmittance set by the occupant via the fixed-side dimmer switch. The first control device 11 transmits the set target voltage Vm* to the power supply control portion of the movable-side dimming film drive device 4, transmits the set target voltage Vf* to the power supply control portion of the fixed-side dimming film drive device 5 (step S175), and temporarily ends the target voltage setting routine.

On the other hand, when the movable panel 2 slides toward the open side or the closed side due to the operation of the roof opening/closing switch by the occupant of the vehicle V (step S155: NO), the first control device 11 sets a predetermined voltage value corresponding to the maximum transmittance to a target voltage Vm* of the voltage applied to the movable-side dimming film 21 of the movable panel 2, so that the transmittance of the movable panel 2 becomes the maximum transmittance (in the present embodiment, for example, 60% to 65%) (step S185). The maximum transmittance does not necessarily have to be the actual maximum transmittance of the movable panel 2, and may be a predetermined transmittance. In addition, in step S185, the first control device 11 uses the target voltage setting map illustrated in FIG. 5 to set the target voltage Vf* of the voltage applied to the fixed-side dimming film 31 so that the transmittance of the fixed panel 3 corresponding to the output voltage Vsf of the fixed-side sensor 32 acquired in step S100 becomes the target transmittance set by the occupant via the fixed-side dimmer switch. Furthermore, the first control device 11 transmits the set target voltage Vm* to the power supply control portion of the movable-side dimming film drive device 4, transmits the set target voltage Vf* to the power supply control portion of the fixed-side dimming film drive device 5 (step S185), and temporarily ends the target voltage setting routine.

In addition, when the movable panel 2 is at least partially opened and stopped in response to the operation of the roof opening/closing switch by the occupant of the vehicle V (step S165: NO), the first control device 11 sets the voltage value corresponding to the maximum transmittance as the target voltage Vm* of the voltage applied to the movable-side dimming film 21 of the movable panel 2, and sets a target voltage Vf* of the voltage applied to the fixed-side dimming film 31 so that the transmittance of the fixed panel 3 becomes the target transmittance set by the occupant (step S185). Furthermore, in step S185, the first control device 11 transmits the set target voltage Vm* to the power supply control portion of the movable-side dimming film drive device 4, transmits the set target voltage Vf* to the power supply control portion of the fixed-side dimming film drive device 5, and temporarily ends the target voltage setting routine.

As described above, when the sliding or stationary movable panel 2 at least partially overlaps the fixed panel 3 (step S155: NO, S165: NO), the first control device 11 of the sunroof apparatus 1 controls the movable-side dimming film drive device 4 so that the transmittance of the movable panel 2 becomes the maximum transmittance, and controls the fixed-side dimming film drive device 5 so that the transmittance of the fixed panel 3 becomes the target transmittance (required value) set by the occupant of the vehicle V (step S185). As a result, when the movable panel 2 at least partially overlaps the fixed panel 3, it is possible to prevent the amount of light incident on the vehicle interior of the vehicle V from being insufficient, and by adjusting only the transmittance of the fixed panel 3 based on the detection value of the fixed-side sensor 32, it is possible to easily and appropriately ensure the amount of light incident on the vehicle interior.

On the other hand, when the amount of change ΔVsm in the output voltage Vsm of the movable-side sensor 22 is less than the sharp decrease determination threshold Vn (step S130: YES), the first control device 11 considers that the output voltage Vsm of the movable-side sensor 22, that is, the transmittance of the movable panel 2 is sharply decreased, and turns on the flag Fs (step S140). Furthermore, the first control device 11 stores the target voltages Vm* and Vf* set in step S175 or S185 in the RAM as a return target value Vm0 or Vf0, immediately before it is determined in step S130 that the amount of change ΔVsm is less than the sharp decrease determination threshold Vn (step S150).

Next, the first control device 11 sets the target voltage Vm* of the voltage applied to the movable-side dimming film 21 of the movable panel 2 and the target voltage Vf* of the voltage applied to the fixed-side dimming film 31 of the fixed panel 3 to zero, so that the transmittance of both the movable panel 2 and the fixed panel 3 is the minimum transmittance (in the present embodiment, for example, approximately 20%) (step S160). Furthermore, the first control device 11 transmits the set target voltage Vm* to the power supply control portion of the movable-side dimming film drive device 4, transmits the set target voltage Vf* to the power supply control portion of the fixed-side dimming film drive device 5 (step S170), and temporarily ends the target voltage setting routine. The minimum transmittance does not necessarily have to be the actual minimum transmittance of the movable panel 2, and may be a predetermined transmittance.

After the flag Fs is turned on in step S140, when the target voltage setting routine is executed again, it is determined in step S120 that the flag Fs is turned on (step S120: NO). In this case, the first control device 11 determines whether or not the amount of change ΔVsm in the output voltage Vsm of the movable-side sensor 22 calculated in step S110 is equal to or greater than a predetermined sharp increase determination threshold Vp (step S180). The sharp increase determination threshold Vp is a positive value determined in advance through experiments and analysis so that it can be determined that the amount of light incident on the vehicle interior is sharply increased within a short time. The absolute values of the sharp increase determination threshold Vp and the sharp decrease determination threshold Vn may be the same value or may be different values. When the amount of change ΔVsm is less than the sharp increase determination threshold Vp (step S180: NO), the first control device 11 considers that the output voltage Vsm of the movable-side sensor 22, that is, the transmittance of the movable panel 2, is not sharply increased, executes the processing of steps S160 and S170, and temporarily ends the target voltage setting routine.

In addition, when the amount of change ΔVsm in the output voltage Vsm of the movable-side sensor 22 is equal to or greater than the sharp increase determination threshold Vp (step S180: YES), the first control device 11 considers that the output voltage Vsm of the movable-side sensor 22, that is, the transmittance of the movable panel 2 is sharply increased, sets the sum of the target voltage Vm* set at the previous execution of the target voltage setting routine and a predetermined rate value δ as the target voltage Vm*, and sets the sum of the target voltage Vf* set at the previous execution of the target voltage setting routine and the rate value δ as the target voltage Vf* (step S190). The rate value δ is a positive value adapted through experiments and analysis so as to gradually increase the transmittance of the movable panel 2 and the fixed panel 3 to the extent that the occupant of vehicle V does not feel uncomfortable.

Furthermore, the first control device 11 determines whether the target voltage Vm* set in step S190 substantially matches the return target value Vm0 stored in step S150, and determines whether or not the target voltage Vf* set in step S190 substantially matches the return target value Vf0 stored in step S150 (step S200). When at least one of the target voltages Vm* and Vf* is not included within the predetermined range centered on the return target value Vm0 or Vf0 (step S200: NO), the first control device 11 transmits the set target voltage Vm* to the power supply control portion of the movable-side dimming film drive device 4, transmits the set target voltage Vf* to the power supply control portion of the fixed-side dimming film drive device 5 (step S170), and temporarily ends the target voltage setting routine.

In addition, when the target voltage Vm* set in step S190 substantially matches the return target value Vm0 stored in step S150, and the target voltage Vf* set in step S190 substantially matches the return target value Vf0 stored in step S150 (step S200: YES), the first control device 11 turns off the flag Fs (step S210), transmits the target voltage Vm* to the power supply control portion of the movable-side dimming film drive device 4, transmits the target voltage Vf* to the power supply control portion of the fixed-side dimming film drive device 5 (step S170), and temporarily ends the target voltage setting routine.

As described above, the first control device 11 of the sunroof apparatus 1 controls the movable-side dimming film drive device 4 and the fixed-side dimming film drive device 5 so that the transmittance of the movable panel 2 and the fixed panel 3 is the minimum transmittance in response to a sharp decrease in the output voltage Vsm (detection value) of the movable-side sensor 22 (steps S100 to S180). As a result, when the amount of light around the vehicle V sharply decreases in a short time due to, for example, the vehicle V entering a tunnel or a decrease in street lights, and the movable-side dimming film 21 and the fixed-side dimming film 31 cannot be controlled so as to follow changes in the amount of light incident on the vehicle interior, it is possible to satisfactorily suppress the feeling of an unpleasant change in the amount of light to the occupant in the vehicle interior.

In addition, when the output voltage Vsm of the movable-side sensor 22 sharply decreases and then sharply increases (step S180: YES), the first control device 11 sets target voltages Vm* and Vf* based on the return target values Vm0 and Vf0, which are the target voltages Vm* and Vf* immediately before the amount of change ΔVsm is determined to be less than the sharp decrease determination threshold Vn (S180, S190). As a result, the movable-side dimming film drive device 4 and the fixed-side dimming film drive device 5 are controlled so that the transmittance of the movable panel 2 and the fixed panel 3 becomes the value immediately before the output voltage Vsm sharply decreases. As a result, when the amount of light around the vehicle V sharply increases in a short time due to, for example, the vehicle V exiting a tunnel or turning on a street light, it is possible to suppress the feeling of discomfort caused by the change in the amount of light to the occupant in the vehicle interior.

Furthermore, when the output voltage Vsm of the movable-side sensor 22 sharply decreases and then sharply increases (step S180: YES), the first control device 11 gradually increases the target voltages Vm* and Vf* based on the return target values Vm0 and Vf0 (S180, S190). As a result, the movable-side dimming film drive device 4 and the fixed-side dimming film drive device 5 are controlled so that the transmittance of the movable panel 2 and the fixed panel 3 gradually increases to the value immediately before the output voltage Vsm sharply decreases. As a result, in the sunroof apparatus 1, when the amount of light around the vehicle V sharply increases in a short time, it is possible to very effectively suppress the feeling of discomfort caused to the occupant in the vehicle interior due to the change in the amount of light.

Steps S130 and S180 in FIG. 6 may be steps for determining whether or not the output voltage Vsf is sharply decreased or increased based on the amount of change in the output voltage Vsf of the fixed-side sensor 32. In addition, steps S130 and S180 in FIG. 6 may be steps for determining whether or not both the output voltages Vsm and Vsf are sharply decreased or increased based on the amount of change ΔVsm in the output voltages Vsm and Vsf of the movable-side sensor 22 and the fixed-side sensor 32. Furthermore, step S160 in FIG. 6 may be a step of setting one of the target voltages Vm* and Vf* to zero, so that the transmittance of either the movable panel 2 or the fixed panel 3 is the minimum transmittance.

In addition, when the movable panel 2 at least partially overlaps the fixed panel 3, the first control device 11 of the sunroof apparatus 1 controls the movable-side dimming film drive device 4 so that the transmittance of the movable panel 2 becomes the maximum transmittance, and controls the fixed-side dimming film drive device 5 so that the transmittance of the fixed panel 3 becomes the target transmittance (required value), but the disclosure is not limited thereto. For example, when it is determined in step S155 of FIG. 7 that the movable panel 2 slides toward the open side or the closed side (step S155: NO), the first control device 11 may be a control device that controls the movable-side dimming film drive device 4 so that the transmittance of the movable panel 2 is the maximum transmittance, and controls the fixed-side dimming film drive device 5 so that the transmittance of the fixed panel 3 is maintained at the transmittance when the movable panel 2 starts moving. Furthermore, when it is determined in step S155 of FIG. 7 that the movable panel 2 slides toward the open side or the closed side (step S155: NO), it may be further determined whether or not the movable panel 2 slides toward the open side. When the movable panel 2 slides toward the open side, the processing of step S185 may be executed, and when the movable panel 2 slides toward the closed side, the processing of step S175 may be executed. That is, when the movable panel 2 slides toward the closed side, the movable-side dimming film drive device 4 and the fixed-side dimming film drive device 5 may be controlled so that the transmittances of both the movable panel 2 and the fixed panel 3 are each target transmittance.

Furthermore, a plurality of movable-side sensors 22 may be disposed on the movable panel 2, and a plurality of fixed-side sensors 32 may be disposed on the fixed panel 3. In this case, the transmittance of the movable panel 2 may be derived from the average value of the detection values of the plurality of movable-side sensors 22, and the transmittance of the fixed panel 3 may be derived from the average value of the detection values of the plurality of fixed-side sensors 32. In addition, in the sunroof apparatus 1, the first control device 11 and the power supply control portion 40 may be integrated, or the first and second control devices 11 and 12 may be integrated.

According to an aspect of this disclosure, a sunroof apparatus of the present disclosure includes a movable panel and a fixed panel, and is equipped on a vehicle, the device including a movable-side dimming film provided on the movable panel, a fixed-side dimming film provided on the fixed panel, a movable-side dimming film drive device that drives the movable-side dimming film, a fixed-side dimming film drive device that drives the fixed-side dimming film, a movable-side sensor attached to the movable panel to acquire a transmittance of the movable panel, a fixed-side sensor attached to the fixed panel to acquire a transmittance of the fixed panel, and a control device that controls at least one of the movable-side dimming film drive device and the fixed-side dimming film drive device so that the transmittance of at least one of the movable panel and the fixed panel is changed, based on a detection value of at least one of the movable-side sensor and the fixed-side sensor.

In the sunroof apparatus of the present disclosure, the movable-side dimming film is provided on the movable panel, and the fixed-side dimming film is provided on the fixed panel. Furthermore, the movable-side sensor is attached to the movable panel to acquire the transmittance of the movable panel, and the fixed-side sensor is attached to the fixed panel to acquire the transmittance of the fixed panel. As a result, at least one of the movable-side dimming film drive device and the fixed-side dimming film drive device is controlled so that the transmittance of at least one of the movable panel and the fixed panel is changed based on the detection values of at least one of the movable-side sensor and the fixed-side sensor, and the transmittance of the movable panel and the fixed panel can be individually adjusted with high precision. As a result, it is possible to further improve the light transmission characteristics of the sunroof apparatus including the movable panel and the fixed panel.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

### INDUSTRIAL APPLICABILITY

The technique of this disclosure can be utilized in the manufacturing industry of a sunroof apparatus.

What is claimed is:

1. A sunroof apparatus that includes a movable panel and a fixed panel, and is equipped on a vehicle, the apparatus comprising:
a movable-side dimming film provided on the movable panel;
a fixed-side dimming film provided on the fixed panel;
a movable-side dimming film drive device that drives the movable-side dimming film;
a fixed-side dimming film drive device that drives the fixed-side dimming film;
a movable-side sensor attached to the movable panel to acquire a transmittance of the movable panel;
a fixed-side sensor attached to the fixed panel to acquire a transmittance of the fixed panel; and
a control device that controls at least one of the movable-side dimming film drive device and the fixed-side dimming film drive device so that the transmittance of at least one of the movable panel and the fixed panel is changed, based on a detection value of at least one of the movable-side sensor and the fixed-side sensor.

2. The sunroof apparatus according to claim 1,
wherein the movable panel is slidable to overlap on the fixed panel, and
when the movable panel slides toward a fixed panel side and the movable panel is stopped while at least partially overlapping the fixed panel, the control device controls the movable-side dimming film drive device so that the transmittance of the movable panel is a maximum transmittance, and controls the fixed-side dimming film drive device so that the transmittance of the fixed panel is a required value.

3. The sunroof apparatus according to claim 1,
wherein the movable panel is slidable to overlap on the fixed panel, and
the control device controls at least one of the movable-side dimming film drive device and the fixed-side dimming film drive device so that the transmittance of at least one of the movable panel and the fixed panel is a minimum transmittance, in response to a sharp decrease in the detection value of at least one of the movable-side sensor and the fixed-side sensor.

4. The sunroof apparatus according to claim 3,
wherein when the detection value of at least one of the movable-side sensor and the fixed-side sensor sharply decreases and then sharply increases, the control device controls at least one of the movable-side dimming film drive device and the fixed-side dimming film drive device so that the transmittance of at least one of the movable panel and the fixed panel is set to a value immediately before the detection value sharply decreases.
